(19) United States
(12) Patent Application Publication
(10) Pub. No.: US 2025/0237870 A1
(43) Pub. Date: Jul. 24, 2025

(54) LIGHT FIELD DISPLAY SYSTEM

(71) Applicant: PetaRay Inc., New Taipei City (TW)

(72) Inventors: Chi-Feng LEE, New Taipei City (TW); Chao-Chien WU, New Taipei City (TW); Homer H. CHEN, New Taipei City (TW)

(21) Appl. No.: 19/028,684

(22) Filed: Jan. 17, 2025

Related U.S. Application Data
(60) Provisional application No. 63/624,286, filed on Jan. 24, 2024.

(51) Int. Cl. G02B 27/01

(52) U.S. Cl. CPC G02B 27/0172

(57) ABSTRACT

A light field display system consists of a light field generator and a waveguide. The light field generator is configured to output a light field signal. The light field signal consists of a set of light beams. The waveguide is configured to diffract the set of light beams by the total internal reflection and to transmit the light field signal to a viewer.

### CROSS REFERENCE TO RELATED APPLICATIONS

This application claims priority of U.S. Patent Application No. 63/624,286, filed on Jan. 24, 2024, the entirety of which is incorporated by reference herein.

### BACKGROUND OF THE INVENTION

### Field of the Invention

The present invention relates to a display system, and, in particular, to a light field display system.

### Description of the Related Art

The current development of AR/VR display technology is advancing toward improved compatibility with human visual comfort. Generally speaking, a light field display can bring greater comfort to the human eye. However, most waveguides that were developed for use in conventional AR/VR displays cannot maintain the structure of the light field.

### BRIEF SUMMARY OF THE INVENTION

An embodiment of the present invention provides a light field display system. The light field display system consists of a light field generator and a waveguide. The light field generator is configured to output a light field signal corresponding to a light field data array of a scene. The light field signal consists of a set of light beams. The waveguide is configured to diffract the set of light beams by total internal reflection. The waveguide maintains a structure of the light field signal when the light field signal leaves the waveguide.

In one embodiment, the light field generator produces a collimated light field. The collimated light field is related to the light beams originated from a plurality of pixels of the light field generator, and the light beams output by the light field generator are parallel to each other.

In one embodiment, the light field signal produced by the light field generator consists of a plurality of sub light field signals, and the plurality of sub light field signals are related to the set of light beams.

In one embodiment, the light field display system further includes an in-coupler. The in-coupler serves as an interface between the light field generator and the waveguide.

In one embodiment, the light field display system further includes an out-coupler. The out-coupler diffracts the light beams out of the waveguide.

In one embodiment, the light field display system further includes an optical relay module to adjust a magnification of the light field signal.

In one embodiment, the waveguide consists of a single substrate. The waveguide transmits light field signal. The light field signal may be chromatic or monochromatic.

In one embodiment, the waveguide substrate is optimized to ensure a total internal reflection for a diffracted light field signal. The diffracted light field signal is related to the light field signal. The light field signal may be chromatic or monochromatic.

In one embodiment, the waveguide consists of a plurality of substrates, and the plurality of substrates transmit a chromatic light field signal.

In one embodiment, the plurality of waveguide substrates are optimized to ensure a total internal reflection for a diffracted light field signal within each of the plurality of waveguide substrates. The diffracted light field signal is related to the light field signal.

In one embodiment, a chief ray is related to the light beams. The waveguide preserves a light field structure by directing the chief ray to have no intersection with the in-coupler after the chief ray is diffracted from the center of the in-coupler. The chief ray propagates through the waveguide by total internal reflection.

In one embodiment, the first length of the in-coupler is less than the second length of an exit pupil of the light field generator. The exit pupil is located between the waveguide and the light field generator.

In one embodiment, calculation of the F-number uses the following formula:

$$F \# = \frac{{P}_{x}}{f} {N}_{V} {N}_{H} .$$

The F-number of a micro-projector of the light field generator is represented by F #. The second length of the exit pupil of the light field generator is represented by Pₓ. The effective focal length of the light field generator is represented by f. The number of micro-projectors of the light field generator in the vertical direction is represented by N_{V}. The number of micro-projectors of the light field generator in the horizontal direction is represented by N_{H}.

In one embodiment, the actual value of the F-number is within a range. The range is from one half of the calculated F-number to twice the calculated F-number.

In one embodiment, the light field generator is configured such that the marginal rays from each micro-projector converge to a point upon exiting the out-coupler.

In one embodiment, the light field display system further includes at least one correction component, and at least one correction component is configured to adjust the depth range of the light field signal.

In one embodiment, at least one correction component includes a first optical element, and the first optical element adjusts the depth range of the light field emitted by the waveguide.

In one embodiment, at least one correction component further includes a second optical element. The first optical element is positioned on the first side of the waveguide.

In one embodiment, the second optical element is positioned on the second side of the waveguide, with the first side and the second side being opposite to each other.

In one embodiment, the angle of the light beams of the light field signal generated by the light field generator can be adjusted by rotating the light field generator.

In one embodiment, the angle of the light beams of the light field signal generated by the light field generator can be adjusted by an optical component. The optical component is placed between the light field generator and the waveguide.

Therefore, according to the technical content of the present disclosure, light field display system shown in the embodiment of the present disclosure can achieve the effect of maintaining the structure of the light field signal through the waveguide, the in-coupler, and the out-coupler.

Other features and aspects of the present disclosure will become apparent from the following detailed description of exemplary embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a diagram showing a top view of a light field display system according to one embodiment of the present disclosure.

FIG. 2 is a diagram showing a perspective view of a light field display system according to one embodiment of the present disclosure.

FIG. 3A is a diagram of a waveguide of a light field display system according to one embodiment of the present disclosure.

FIG. 3B is a diagram of a waveguide of a light field display system according to one embodiment of the present disclosure.

FIG. 3C is a diagram of a waveguide of a light field display system according to one embodiment of the present disclosure.

FIG. 3D is a diagram of a waveguide of a light field display system according to one embodiment of the present disclosure.

FIG. 3E is a diagram of a waveguide of a light field display system according to one embodiment of the present disclosure.

FIG. 3F is a diagram of a waveguide of a light field display system according to one embodiment of the present disclosure.

FIG. 4 is a diagram of a light field display system according to one embodiment of the present disclosure.

FIG. 5 is a diagram of an in-coupler of a light field display system according to one embodiment of the present disclosure.

FIG. 6 is a diagram of a light field display system according to one embodiment of the present disclosure.

FIG. 7 is a diagram of a light field display system according to one embodiment of the present disclosure.

FIG. 8 is a diagram of a light field display system according to one embodiment of the present disclosure.

FIG. 9 is a diagram of a light field display system according to one embodiment of the present disclosure.

FIG. 10 is a diagram of a light field display system according to one embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

Various exemplary embodiments, features, and aspects of the present disclosure are described in detail below with reference to the accompanying drawings. The same reference numbers in the drawings identify functionally identical or similar elements. Although various aspects of the embodiments are illustrated in the drawings, the drawings are not necessarily drawn to scale unless otherwise specified.

The word “exemplary” as used herein means “serving as an example, example, or illustrative.” Any embodiment described herein as “exemplary” is not necessarily to be construed as superior or superior to other embodiments.

In addition, in order to better explain the present disclosure, numerous specific details are provided in the following specific embodiments. It will be understood by those skilled in the art that the present disclosure may be practiced without certain specific details. In some instances, methods, means, components and circuits that are well known to those skilled in the art are not described in detail in order to highlight the gist of the disclosure.

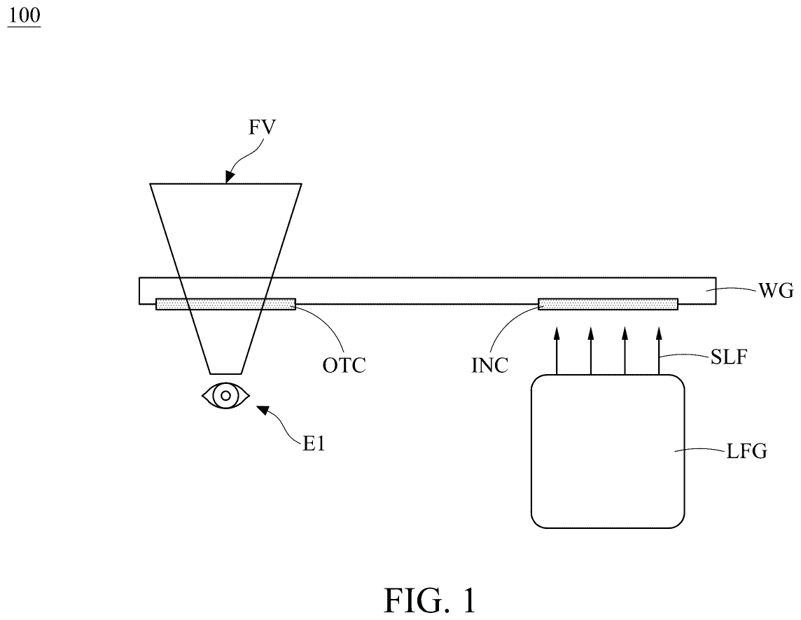

FIG. 1 is a diagram of a light field display system according to one embodiment of the present disclosure. As shown in FIG. 1, in one embodiment, the light field display system 100 consists of a light field generator LFG and a waveguide WG. For example, a length range of the waveguide WG can be about 1-10 centimeters (cm), and a thickness range of the waveguide WG can be about 0.1-10 millimeters, but the present disclosure is not limited thereto.

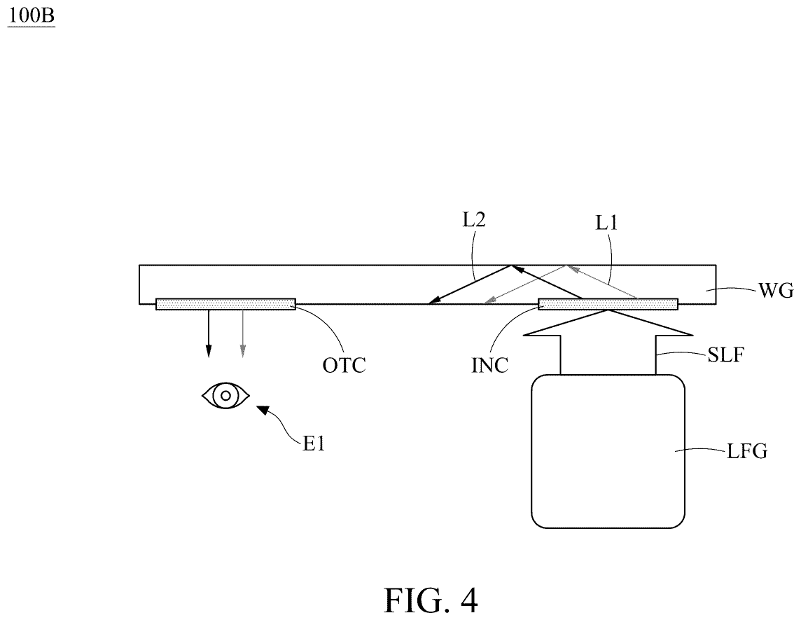

In this embodiment, the light field generator LFG is configured to output a light field signal SLF. For example, the light field signal SLF can enhance viewers' perception of augmented reality (AR), but the present disclosure is not limited thereto. In this embodiment, the light field signal SLF consists of a set of light beams. For example, the set of light beams may correspond to the light beams L1 and L2 in FIG. 4, but the present disclosure is not limited thereto. In this embodiment, the waveguide WG is configured to diffract the set of light beams by total internal reflection and to transmit the light field signal SLF to the viewer. For example, the waveguide WG can transmit the light field signal SLF to the viewer's eye E1 (specifically, to the retina of the viewer), and the viewer's eye E1 can obtain a field of view according to the light field signal SLF, but the present disclosure is not limited thereto.

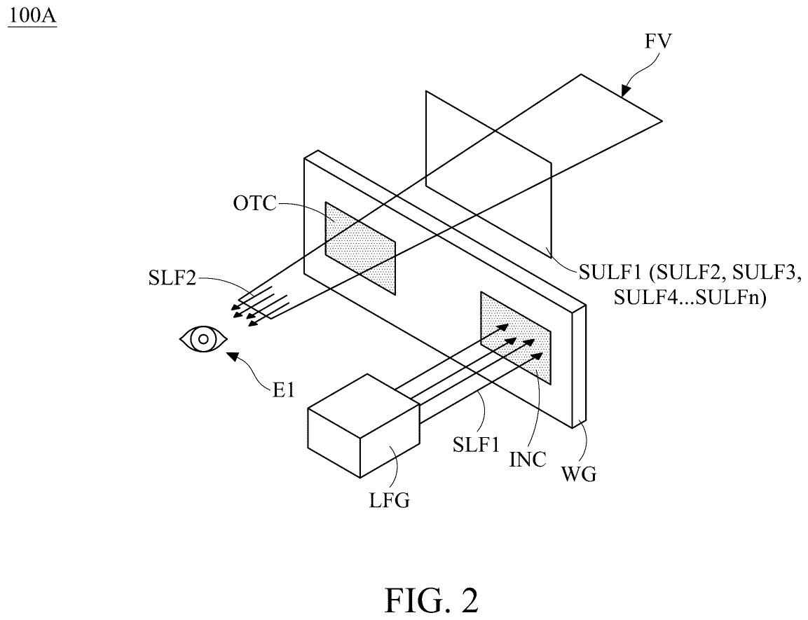

In one embodiment, the waveguide WG maintains a structure of the light field signal SLF when the light field leaves the waveguide WG. The light field generator LFG outputs the light field signal SLF based on (corresponding to) a light field data array of a scene. The light field generator LFG produces a collimated light field. The collimated light field is related to the light beams originated from a plurality of pixels of the light field generator LFG, the light beams are parallel to each other. For example, the light field generator LFG may have micro-display panel with a plurality of pixels. The light field generator LFG collimates the light beams emanated from the plurality of pixels, but the present disclosure is not limited thereto. In some embodiments, the light field data array of the scene may correspond to the signals SULF1, SULF2, SULF3, and SULF4 in FIG. 2, but the present disclosure is not limited thereto. In some embodiments, the light field data array of the scene is related to the signals SULF1, SULF2, SULF3, and SULF4 in FIG. 2, but the present disclosure is not limited thereto.

In some embodiments, the light beams may correspond to the light beams L1 and L2 in FIG. 4, but the present disclosure is not limited thereto. In some embodiments, as shown in FIG. 2, the light field structure of the light field signal SLF1 received by the waveguide WG is the same as the light field structure of the light field signal SLF2 output by the waveguide WG, but the present disclosure is not limited thereto. In some embodiments, the structure of the light field signal SLF1 received by the waveguide WG is similar to the structure of the light field signal SLF2 output by the waveguide WG, but the present disclosure is not limited thereto.

In some embodiments, a 4-D image array input to the light field generator is the light field data array, or light field data for short. Each pixel of the 4-D image array is addressed by an x-coordinate and a y-coordinate, which are the spatial coordinates of the pixel, and two angular coordinates, which specify the view direction from which the image is captured. The output of the light field generator is a set of light beams, collectively called light field.

In some embodiments, the four coordinates used to specify a pixel of the light field data array also serve as the coordinates to specify the position and orientation of the light beam corresponding to the pixel, but the present disclosure is not limited thereto. In some embodiments, the waveguide WG maintains a light field structure of the light field signal SLF, meaning that the light beams with the same spatial coordinates but different angular coordinates shall maintain their angular relation after passing through the in-coupler INC, the waveguide WG, and the out-coupler OTC to reach the retina of the viewer, but the present disclosure is not limited thereto.

FIG. 2 is a diagram of a light field display system according to one embodiment of the present disclosure. In one embodiment, FIG. 2 may be a perspective view of the light field display system shown in FIG. 1, and the light field display system 100A in FIG. 2 may correspond to the light field display system 100 in FIG. 1. In some embodiments, the operations and the hardware structures of the light field display system 100A in FIG. 2 may be similar to the operations and the hardware structures of the light field display system 100 in FIG. 1, but the present disclosure is not limited thereto.

Please refer to FIG. 1 and FIG. 2. In one embodiment, the light field signal SLF1 or SLF consists of a plurality of sub light field signals SULF1, SULF2, SULF3, and SULF4, and the plurality of sub light field signals SULF1, SULF2, SULF3, and SULF4 are related to the set of light beams output by the light field generator. For example, there may be four sub light field signals SULF1, SULF2, SULF3, and SULF4. The light field signal SLF1 or SLF may be a four-dimensional (4-D) signal. Each of the plurality of sub light field signals SULF1, SULF2, SULF3, and SULF4 may correspond to a 2-D array of image data, but the present disclosure is not limited thereto.

In some embodiments, there may be n sub light field signals SULF1-SULFn, and n is a positive integer. In some embodiments, the number of sub light field signals may be any quantity, but the present disclosure is not limited thereto.

In one embodiment, the light field display system 100 or 100A further includes an in-coupler INC. The in-coupler INC serves as the interface between the light field generator LFG and the waveguide WG. For example, the in-coupler INC may be located on the waveguide WG and may be an optical component or an diffractive component, but the present disclosure is not limited thereto. In some embodiments, the optical component may be a convex lens or a concave lens, but the present disclosure is not limited thereto.

In one embodiment, the light field display system 100 or 100A further includes an out-coupler OTC. The out-coupler OTC diffracts the light beams out of the waveguide. For example, the out-coupler OTC may be located on the waveguide WG and may be an diffractive component, but the present disclosure is not limited thereto. In some embodiments, the in-coupler INC and the out-coupler OTC may have a periodic pattern or a plurality of micro structures, but the present disclosure is not limited thereto.

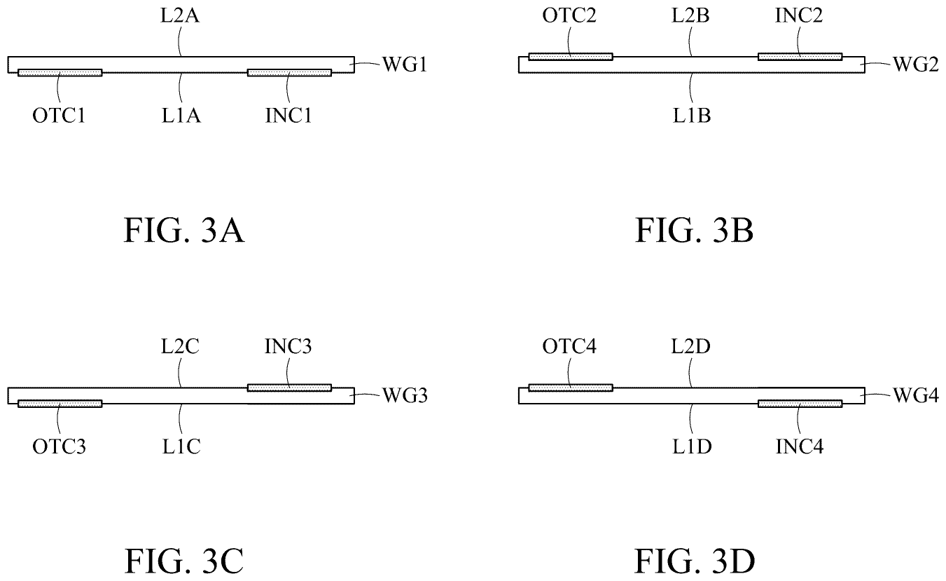

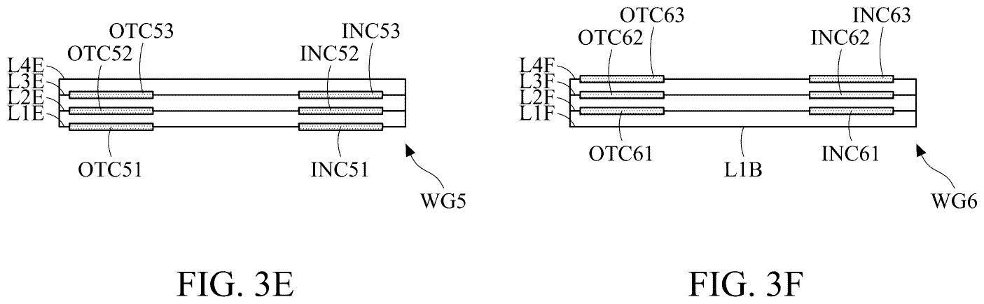

FIG. 3A is a diagram of a waveguide of a light field display system according to one embodiment of the present disclosure. As shown in FIG. 3A, in one embodiment, there have the waveguide WG1, the in-coupler INC1, and the out-coupler OTC1 in a light field display system. The waveguide WG1 has a first side LlA and second side L2A. The in-coupler INC1 may be located on the first side LlA, and the out-coupler OTC1 may also be located on the first side LlA. For example, the waveguide WG1, the in-coupler INC1, and the out-coupler OTC1 in FIG. 3A may correspond to the waveguide WG, the in-coupler INC, and the out-coupler OTC, respectively, in FIG. 1, but the present disclosure is not limited thereto.

FIG. 3B is a diagram of a waveguide of a light field display system according to one embodiment of the present disclosure. As shown in FIG. 3B, in one embodiment, there have the waveguide WG2, the in-coupler INC2, and the out-coupler OTC2 in a light field display system. The waveguide WG2 has a first side LiB and second side L2B. The in-coupler INC2 may be located on the second side L2B, and the out-coupler OTC2 may be located on the second side L2B. For example, the waveguide WG2, the in-coupler INC2, and the out-coupler OTC2 in FIG. 3B may correspond to the waveguide WG, the in-coupler INC, and the out-coupler OTC, respectively, in FIG. 1, but the present disclosure is not limited thereto.

FIG. 3C is a diagram of a waveguide of a light field display system according to one embodiment of the present disclosure. As shown in FIG. 3C, in one embodiment, there have the waveguide WG3, the in-coupler INC3, and the out-coupler OTC3 in a light field display system. The waveguide WG3 has a first side LlC and second side L2C. The in-coupler INC3 may be located on the second side L2C, and the out-coupler OTC2 may be located on the first side LlC. For example, the waveguide WG3, the in-coupler INC3, and the out-coupler OTC3 in FIG. 3C may correspond to the waveguide WG, the in-coupler INC, and the out-coupler OTC, respectively, in FIG. 1, but the present disclosure is not limited thereto.

FIG. 3D is a diagram of a waveguide of a light field display system according to one embodiment of the present disclosure. As shown in FIG. 3D, in one embodiment, there have the waveguide WG4, the in-coupler INC4, and the out-coupler OTC4 in a light field display system. The waveguide WG4 has a first side LiD and second side L2D. The in-coupler INC4 may be located on the first side LlD, and the out-coupler OTC4 may be located on the second side L2D. For example, the waveguide WG4, the in-coupler INC4, and the out-coupler OTC4 in FIG. 3D may correspond to the waveguide WG, the in-coupler INC, and the out-coupler OTC, respectively, in FIG. 1, but the present disclosure is not limited thereto.

Please refer to FIGS. 1 and 3A to 3D, in one embodiment, the waveguide WG1, WG2, WG3, or WG4 consists of a single substrate. The single substrate (such as waveguide WG1, WG2, WG3, or WG4) transmits a (diffracted monochromatic or chromatic) light field signal. For example, the waveguide WG1, WG2, WG3, or WG4 may receive and transmit a monochrome light field signal, and the monochrome light field signal may be a red light field signal, a green light field signal, or a blue light field signal, but the present disclosure is not limited thereto.

In one embodiment, the single substrate (such as waveguide WG1, WG2, WG3, or WG4) is optimized to ensure a total internal reflection (within the single substrate) for a diffracted light field signal, and the diffracted light field signal is related to the light field signal. For example, the light field signal SLF in FIG. 1 may be a monochrome light field signal, and the monochrome light field signal may be related to the waveguide WG1, WG2, WG3, or WG4 in FIG. 3A to FIG. 3D. Furthermore, the waveguide WG1 may be related to one of the plurality of the light field signals (such as the red light field signal), the waveguide WG2 may be related to one of the plurality of the light field signals (such as the green light field signal), but the present disclosure is not limited thereto.

FIG. 3E is a diagram of a waveguide of a light field display system according to one embodiment of the present disclosure. As shown in FIG. 3E, in one embodiment, there have the waveguide WG5, the plurality of in-couplers INC51, INC52, and INC53, the plurality of out-couplers OTC51, OTC52, and OTC53, and the plurality of sides LiE, L2E, L3E, and L4E. The in-coupler INC51 and the out-coupler OTC51 may be located on the side LiE. The in-coupler INC52 and the out-coupler OTC52 may be located on the side L2E. The in-coupler INC53 and the out-coupler OTC53 may be located on the side L3E. For example, the waveguide WG5, one of the plurality of in-couplers INC51, INC52, and INC53, and one of the plurality of out-couplers OTC51, OTC52, and OTC53 may correspond to the waveguide WG, the in-coupler INC, and the out-coupler OTC, respectively, in FIG. 1, but the present disclosure is not limited thereto.

FIG. 3F is a diagram of a waveguide of a light field display system according to one embodiment of the present disclosure. As shown in FIG. 3F, in one embodiment, there have the waveguide WG6, the plurality of in-couplers INC61, INC62, and INC63, the plurality of out-couplers OTC61, OTC62, and OTC63, and the plurality of sides LlF, L2F, L3F, and L4F. The in-coupler INC61 and the out-coupler OTC61 may be located on the side LlF. The in-coupler INC62 and the out-coupler OTC62 may be located on the side L2F. The in-coupler INC63 and the out-coupler OTC63 may be located on the side L3F. For example, the waveguide WG6, one of the plurality in-couplers INC61, INC62, and INC63, and one of the plurality of out-couplers OTC61, OTC62, and OTC63 may correspond to the waveguide WG, the in-coupler INC, and the out-coupler OTC in FIG. 1, but the present disclosure is not limited thereto.

Please refer to FIGS. 1, 3E, and 3F. In one embodiment, the waveguide WG5 or WG6 consists of a plurality of waveguide substrates, and the plurality of substrates transmit a (chromatic) light field signal. For example, the waveguide WG5 or WG6 may receive and transmit the (chromatic) light field signal.

Please refer to FIGS. 3E and 3F. In some embodiments, as shown in FIG. 3E, the in-coupler INC51 and the out-coupler OTC51 may be arranged in four ways (such as the arrangements in FIGS. 3A to 3D), the in-coupler INC52 and the out-coupler OTC52 may be arranged in four ways (such as the arrangements shown in FIGS. 3A to 3D), and the in-coupler INC53 and the out-coupler OTC53 may be arranged in four ways (such as the arrangements in FIGS. 3A to 3D).

Therefore, the plurality of in-couplers INC51, INC52, and INC53 and the plurality of out-couplers OTC51, OTC52, and OTC53 in FIG. 3E may be arranged in 4×4×4=64 ways. Similarly, the plurality of in-couplers INC61, INC62, and INC63 and the plurality of out-couplers OTC61, OTC62, and OTC63 in FIG. 3F may be arranged in 4×4×4=64 ways.

In one embodiment, the plurality of waveguide substrates are optimized to ensure a total internal reflection for a diffracted light field signal within each of the plurality of waveguide substrates. The diffracted light field signal is related to the light field signal SLF. The light field signal SLF includes the chromatic light field signal. For example, the light field signal SLF may be a chromatic light field signal, and the chromatic light field signal may be related to the plurality of waveguide substrates. Furthermore, one of the waveguide substrates may be related to the red light field signal, another waveguide substrate may be related to the green light field signal, and the third waveguide substrate may be related to the blue light field signal, but the present disclosure is not limited thereto.

FIG. 4 is a diagram of a light field display system according to one embodiment of the present disclosure. In one embodiment, a part of the light field display system 100B in FIG. 4 may correspond to the light field display system 100 in FIG. 1. What needs special explanation is that the in-coupler INC may diffract and transmit the light beams L1 and L2 of the light field signal SLF through the waveguide WG by total internal reflection, but the present disclosure is not limited thereto. In some embodiments, the light beams L1 and L2 in the waveguide WG may travel to the viewer's eye through the out-coupler OTC, but the present disclosure is not limited thereto.

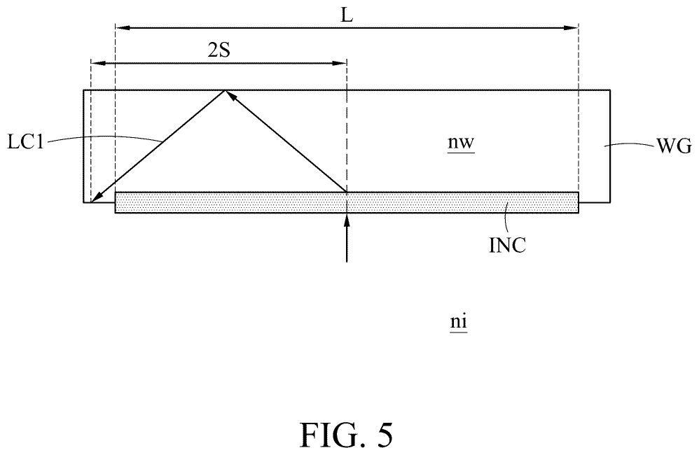

FIG. 5 is a diagram of the in-coupler of a light field display system according to one embodiment of the present disclosure. In one embodiment, the in-coupler INC and the waveguide WG in FIG. 5 may correspond to the in-coupler INC and the waveguide WG in FIG. 1, air outside the in-coupler INC may have a first index of refraction (denoted by ni), and the waveguide WG may have a second index of refraction (denoted by nw). Normally, nw is bigger than ni so that the light beams L1 and L2 in FIG. 4 can transmit through the waveguide WG by total internal reflection, but the present disclosure is not limited thereto.

In one embodiment, a chief ray LC1 is related to the light beams (such as the light beams L1 and L2 in FIG. 4). The waveguide WG preserves a light field structure by directing the chief ray LC1 to have no intersection with the in-coupler INC after the chief ray LC1 is diffracted from the center of the in-coupler INC. The chief ray LC1 propagates through the waveguide WG by total internal reflection. For example, in FIG. 5, the bounce distance (denoted by 2S) of the chief ray LC1 along the substrate after the chief ray LC1 undergoes total internal reflection once is greater than one half of the length (denoted by L) of the in-coupler INC, but the present disclosure is not limited thereto.

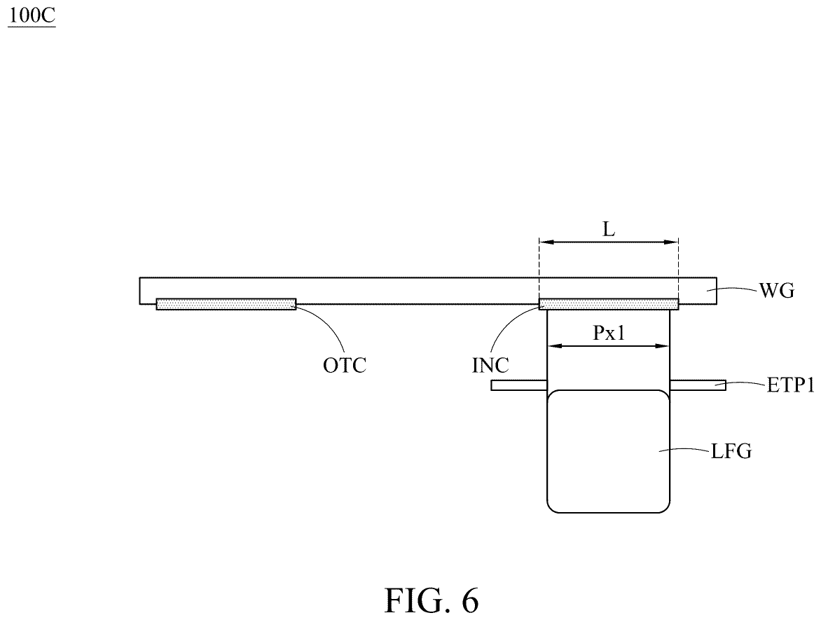

FIG. 6 is a diagram of a light field display system 100C according to one embodiment of the present disclosure. In one embodiment, a part of the light field display system 100C in FIG. 6 may correspond to the light field display system 100 in FIG. 1. What needs special explanation is that a first length L of the in-coupler INC is less than a second length Px1 of the exit pupil ETP1 of the light field generator LFG. The exit pupil ETP1 is located between the waveguide WG and the light field generator LFG. For example, the in-coupler INC in FIG. 6 may correspond to the in-coupler INC in FIG. 5, the first length L of the in-coupler INC in FIG. 6 may correspond to the length (denoted by L) of the in-coupler INC in FIG. 5, but the present disclosure is not limited thereto.

In some embodiments, the length of the out-coupler OTC may be longer than or equal to the first length L of the in-coupler INC, but the present disclosure is not limited thereto. In one embodiment, the calculation of the F-number uses the following formula:

$$F \# = \frac{{P}_{x}}{f} {N}_{V} {N}_{H} .$$

The F-number of a micro-projector of the light field generator is represented by F #. The second length of the exit pupil of the light field generator is represented by Pₓ. The effective focal length of the light field generator is represented by f. The number of micro-projectors of the light field generator in the vertical direction is represented by N_{V}. The number of micro-projectors of the light field generator in the horizontal direction is represented by N_{H}.

In one embodiment, the F-number is set to a value ranging from

$$\frac{{P}_{x}}{2 f} {N}_{V} {N}_{H} to \frac{2 {P}_{x}}{2 f} {N}_{V} {N}_{H} .$$

In some embodiments, the (actual) value of the F-number is within a range. The range is from one half of the calculated F-number to twice the calculated F-number.

In one embodiment, the light field generator LFG is configured such that the marginal rays from each micro-projector converge to a point upon exiting the out-coupler. For example, the point may be located in the viewer's eye E1 in FIG. 1, but the present disclosure is not limited thereto.

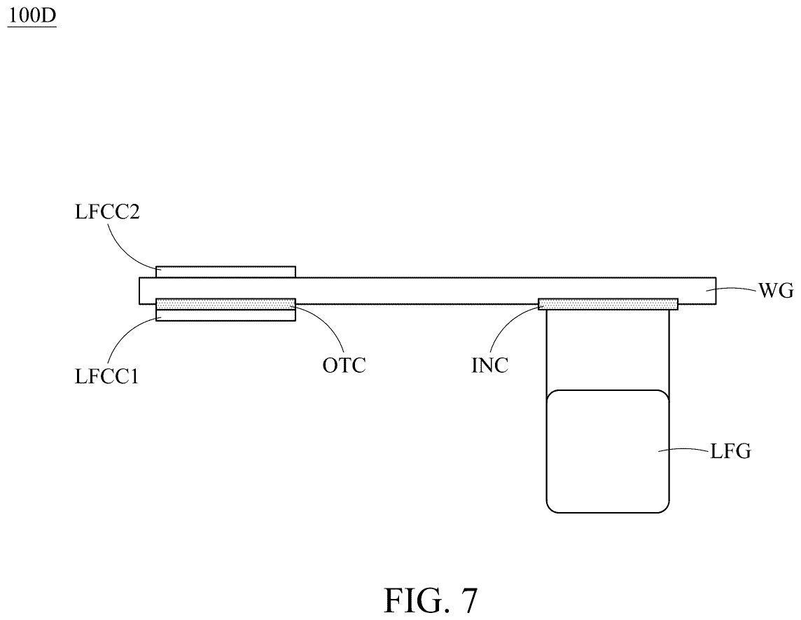

FIG. 7 is a diagram of a light field display system according to one embodiment of the present disclosure. As shown in FIG. 7, in one embodiment, a part of the light field display system 100D in FIG. 7 may correspond to the light field display system 100 in FIG. 1. What needs special explanation is that, the light field display system 100D further includes at least one of correction components LFCC1 and LFCC2, and the at least one of correction components LFCC1 and LFCC2 is configured to adjust the depth range of the light field signal (such as the light field signal SLF in FIG. 1). For example, the at least one of correction components LFCC1 and LFCC2 can adjust the depth range within which the light field can be observed by the human eye E1 in FIG. 1. The depth range observed by the human eye E1 may be related to the depth range of the light field signal SLF in FIG. 1, but the present disclosure is not limited thereto.

In one embodiment, the at least one of correction components LFCC1 and LFCC2 includes a first optical element LFCC1, the first optical element LFCC1 adjusts the light field emitted by the waveguide WG. For example, the first optical element LFCC1 can adjust the virtual image plane and working range by modifying the wavefront of the light field emitted by the waveguide WG, but the present disclosure is not limited thereto.

In one embodiment, the at least one of correction components LFCC1 and LFCC2 further includes a second optical element LFCC2. The first optical element LFCC1 is positioned on the first side of the waveguide WG. For example, the at least one of correction components LFCC1 and LFCC2 may have a first optical element LFCC1 and a second optical element LFCC2. The first optical element LFCC1 and the second optical element LFCC2 may each be any type of optical element, such as a concave lens, a convex lens, or a metalens. Furthermore, the first optical element LFCC1 may be located on the waveguide WG or the out-coupler OTC, but the present disclosure is not limited thereto.

In one embodiment, the second optical element is positioned on the second side of the waveguide WG, the first side and the second side are opposite to each other. For example, the second optical element LFCC2 may be located on the waveguide WG, each of the first optical element LFCC1 and the second optical element LFCC2 may be located on different sides of the waveguide WG, but the present disclosure is not limited thereto.

In some embodiments, the light field display system 100D may only have a first optical element LFCC1, but the present disclosure is not limited thereto. In some embodiments, the light field display system 100D may have the first optical element LFCC1 and the second optical element LFCC2, but the present disclosure is not limited thereto.

In some embodiments, the length of the out-coupler OTC may be the same as the length of the first optical element LFCC1, the length of the out-coupler OTC may be the same as the length of the second optical element LFCC2, but the present disclosure is not limited thereto. In some embodiments, both the length (or the size) of the first optical element LFCC1 and the length (or the size) of the second optical element LFCC2 are greater than the length of the out-coupler OTC, but the present disclosure is not limited thereto.

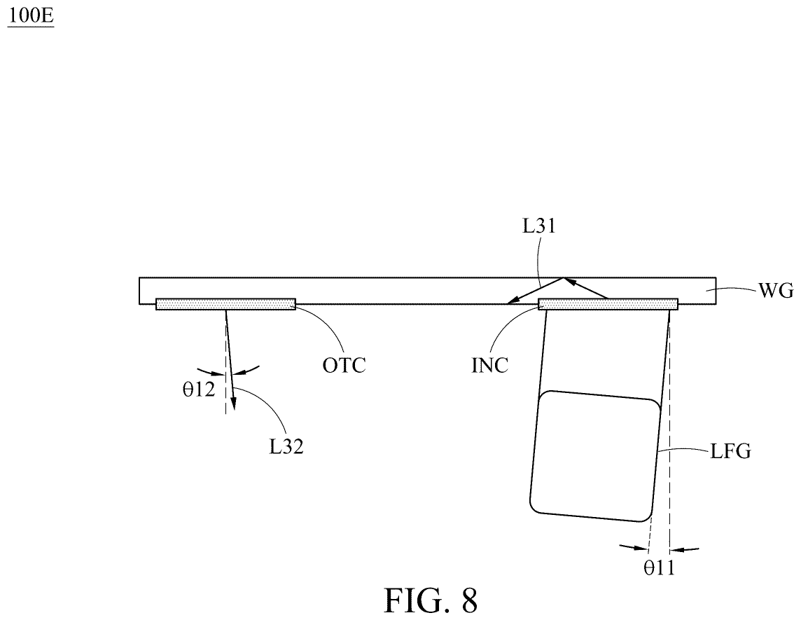

FIG. 8 is a diagram of a light field display system according to one embodiment of the present disclosure. As shown in FIG. 8, in one embodiment, a part of the light field display system 100D in FIG. 8 may correspond to the light field display system 100 in FIG. 1. What needs special explanation is that an angle θ12 of the light beams (such as the light beam L32) of the light field signal (such as the light field signal SLF in FIG. 1) generated by the light field generator LFG can be adjusted by rotating the light field generator LFG by θ11 with respect to the normal of the in-coupler INC in FIG. 8.

For example, the light field generator LFG may have a rotation angle of θ11. The angle between the light field generator LFG and the normal (line) may be a rotation angle of θ11. The angle between the light beam L32 and the normal (line) may be an angle of θ12. The angle θ12 is related to the rotation angle θ11.

In some embodiments, when the light field generator LFG rotates by the angle θ11 to the left, the light beam L32 rotates by the angle θ12 to the right, but the present disclosure is not limited thereto. In some embodiments, when the light field generator LFG rotates by the angle θ11 to the right, the light beam L32 rotates by the angle θ12 to the left, but the present disclosure is not limited thereto.

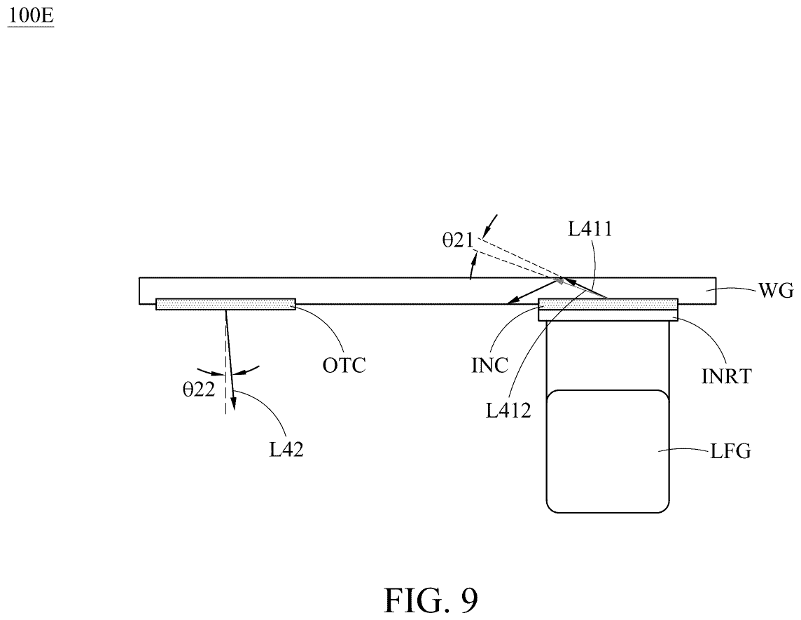

FIG. 9 is a diagram of a light field display system according to one embodiment of the present disclosure. As shown in FIG. 9, in one embodiment, a part of the light field display system 100E may correspond to the light field display system 100 in FIG. 1. What needs special explanation is that an angle θ21 of a light beam L412 of the light field signal (such as the light field signal SLF in FIG. 1) generated by the light field generator LFG can be adjusted by an optical component INRT. The optical component INRT is placed between the light field generator LFG and the waveguide WG.

For example, the light beam L412 can be rotated by the angle θ21 to be the light beam L411 through the optical component INRT, the optical component INRT may be a Liquid-Crystal (LC) component or an LC layer. Furthermore, the angle between the light beam L42 and the normal of the out-coupler OCT may be an angle θ22. The angle θ22 is related to the rotation angle θ21. In some embodiments, the optical component INRT may be an optical element, such as a concave lens, a convex lens, or a metalens, but the present disclosure is not limited thereto.

In some embodiments, when the light beam L411 rotates by the angle θ21 to the left (and to be the light beam L412), the light beam L42 rotates by the angle θ22 to the right to be in the normal direction of the out-coupler OTC, but the present disclosure is not limited thereto. In some embodiments, when the light beam L412 rotates by the angle θ21 to the right (and to be the light beam L411), the light beam coincident with the normal of the out-coupler OTC rotates by the angle θ22 to the left with respect to the normal of the out-coupler (and to be the light beam L42), but the present disclosure is not limited thereto.

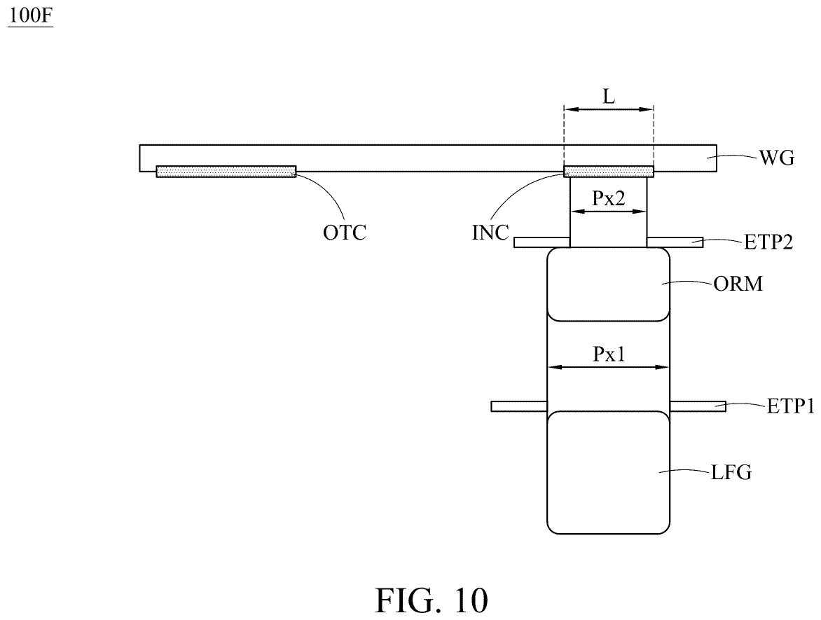

FIG. 10 is a diagram of a light field display system according to one embodiment of the present disclosure. In one embodiment, a part of the light field display system 100F in FIG. 10 may correspond to the light field display system 100C in FIG. 6. What needs special explanation is that the light field display system 100F further includes an optical relay module ORM to adjust a magnification of the light field signal (such as the light field signal SLF in FIG. 1). For example, the optical relay module ORM may be any type of optical lens, such as a concave lens, a convex lens, or a metalens, and the optical relay module ORM may be located between the waveguide WG and the light field generator LFG, but the present disclosure is not limited thereto.

In some embodiments, the light field display system 100F further includes the exit pupil ETP2. The exit pupil ETP2 may be located between the optical relay module ORM and the waveguide WG. The exit pupil ETP2 may have a third length Px2, and the third length Px2 is less than or equal to the first length L of the in-coupler INC, but the present disclosure is not limited thereto. In some embodiments, the optical relay module ORM can enhance the light intensity of the light field signal SLF in FIG. 1, but the present disclosure is not limited thereto. In some embodiments, the first length L of the in-coupler INC is less than a second length Px1 of the exit pupil ETP1 of the light field generator LFG. The exit pupil ETP1 may be located between the optical relay module ORM and the light field generator LFG.

In some embodiments, the light field display system 100, 100A, 100B, 100C, 100D, 100E, or 100F may be the diffractive light field AR display system, and the light field display system 100, 100A, 100B, 100C, 100D, 100E, or 100F may be a device for displaying light field data (or the light field signal SLF in FIG. 1), but the present disclosure is not limited thereto. In some embodiments, the light field (or the light field signal SLF in FIG. 1) may be a collection of light beams. In the present, the light field may be considered as a four-dimensional signal, where two dimensions describe the position of the light beam, and the other two dimensions describe the direction of the light beam, but the present disclosure is not limited thereto.

In some embodiments, the sub-light-field (or any of the plurality of sub light field signals SULF1, SULF2, SULF3, and SULF4 in FIG. 2) is a two-dimensional subset of the light field. Fixing the two angular coordinates of a light field gives rise to a sub-aperture view of the light field, but the present disclosure is not limited thereto. In some embodiments, the four-dimensional image array (or light field signal SLF in FIG. 1) describes the RGB values of each light beam of the light field, but the present disclosure is not limited thereto.

In some embodiments, a two-dimensional image array of any of plurality of sub light field signals SULF1, SULF2, SULF3, and SULF4 in FIG. 2 describes the RGB values of each light beam of a sub-light-field, but the present disclosure is not limited thereto. In some embodiments, the waveguide WG in the present disclosure is developed for light field AR/VR displays, but the present disclosure is not limited thereto. Therefore, according to the technical content of the present disclosure, the light field display system shown in the embodiment of the present disclosure can achieve the effect of maintaining the structure of the light field signal through the waveguide, the in-coupler, and the out-coupler. Furthermore, the light field display system shown in the embodiment can bring greater comfort to the human eye.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light field display system, comprising:
a light field generator, configured to output a light field signal corresponding to a light field data array of a scene, wherein the light field signal comprises a set of light beams; and
a waveguide, configured to diffract the set of light beams by a total internal reflection, wherein the waveguide maintains a structure of the light field signal when the light field signal leaves the waveguide.

2. The light field display system as claimed in claim 1, wherein
the light field generator produces a collimated light field,
wherein the collimated light field is related to the light beams originated from a plurality of pixels of the light field generator, and the light beams are parallel to each other.

3. The light field display system as claimed in claim 1, wherein
the light field signal comprises a plurality of sub light field signals, and the plurality of sub light field signals are related to the set of light beams.

4. The light field display system as claimed in claim 1, wherein
the light field display system further comprises an in-coupler, and the in-coupler serves as an interface between the light field generator and the waveguide.

5. The light field display system as claimed in claim 1, wherein
the light field display system further comprises an out-coupler, and the out-coupler diffracts the light beams out of the waveguide.

6. The light field display system as claimed in claim 1, wherein
the light field display system further comprises an optical relay module to adjust a magnification of the light field signal.

7. The light field display system as claimed in claim 1, wherein
the waveguide comprises a single substrate, and the single substrate transmits the light field signal.

8. The light field display system as claimed in claim 7, wherein
the single substrate is optimized to ensure the total internal reflection for a diffracted light field signal, and the diffracted light field signal is related to the light field signal.

9. The light field display system as claimed in claim 1, wherein
the waveguide comprises a plurality of waveguide substrates, and the plurality of waveguide substrates transmit the light field signal.

10. The light field display system as claimed in claim 9, wherein
the plurality of waveguide substrates are optimized to ensure the total internal reflection for a diffracted light field signal within each of the plurality of waveguide substrates, and the diffracted light field signal is related to the light field signal,
wherein the light field signal comprises a chromatic light field signal.

11. The light field display system as claimed in claim 4, wherein
a chief ray is related to the light beams,
wherein the waveguide preserves a light field structure by directing the chief ray to have no intersection with the in-coupler after the chief ray is diffracted from a center of the in-coupler,
wherein the chief ray propagates through the waveguide by the total internal reflection.

12. The light field display system as claimed in claim 4, wherein
a first length of the in-coupler is less than a second length of an exit pupil of the light field generator,
wherein the exit pupil is located between the waveguide and the light field generator.

13. The light field display system as claimed in claim 12, wherein
a calculation of an F-number uses a following formula:
$$F \# = \frac{{P}_{x}}{f} {N}_{V} {N}_{H}$$
wherein the F-number of a micro-projector of the light field generator is represented by F #,
wherein the second length of the exit pupil of the light field generator is represented by Pₓ,
wherein an effective focal length of the light field generator is represented by f,
wherein a first number of micro-projectors of the light field generator in vertical direction is represented by N_{V},
wherein a second number of micro-projectors of the light field generator in horizontal direction is represented by N_{H},
wherein the F-number is set to a value ranging from
$$\frac{{P}_{x}}{2 f} {N}_{V} {N}_{H} to \frac{2 {P}_{x}}{f} {N}_{V} {N}_{H} .$$

14. The light field display system as claimed in claim 13, wherein
the light field generator is configured such that marginal rays from each of the micro-projectors converge to a point upon exiting an out-coupler.

15. The light field display system as claimed in claim 1, wherein
the light field display system further comprises at least one of correction components, and the at least one of correction components is configured to adjust a depth range of the light field signal.

16. The light field display system as claimed in claim 15, wherein
the at least one of correction components comprises a first optical element, the first optical element adjusts a light field emitted by the waveguide.

17. The light field display system as claimed in claim 16, wherein
the at least one of correction components further comprises a second optical element,
wherein the first optical element is positioned on a first side of the waveguide.

18. The light field display system as claimed in claim 17, wherein
the second optical element is positioned on a second side of the waveguide, and the first side and the second side are opposite to each other.

19. The light field display system as claimed in claim 1, wherein
an angle of the light beams of the light field signal generated by the light field generator be adjusted by rotating the light field generator.

20. The light field display system as claimed in claim 1, wherein
an angle of the light beams of the light field signal generated by the light field generator be adjusted by an optical component,
wherein the optical component is placed between the light field generator and the waveguide.
